(19) United States
(12) Patent Application Publication
(10) Pub. No.: US 2003/0172137 A1
(43) Pub. Date: Sep. 11, 2003

(54) Communication controlling device, communication controlling method and image forming system

(75) Inventor: Kazuto Yoshida, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/372,729

(22) Filed: Feb. 24, 2003

(30) Foreign Application Priority Data
Mar. 7, 2002 (JP) 2002-062043

(51) Int. Cl. G06F 15/177; H04Q 1/00

(52) U.S. Cl. 709/220; 340/825; 709/223; 709/230; 370/254

(57) ABSTRACT

A communication controlling device includes a communication controller having a plurality of data receiving sections for carrying out data communication by using a plurality of communication tools having different communication systems from each other, the communication controller controlling each operating condition of the plurality of communication tools; and a supervisory controller for previously judging whether a received data received by the communication controller is valid and for specifying one communication tool through which data should be continuously transmitted. A data storage stores the received data which is judged to be valid. An access controller controls operating conditions of the supervisory controller and the data storage. The access controller also controls an operating condition of the communication controller so that the data is continuously transmitted through an effective communication tool for the received data which is previously judged to be valid.

### BACKGROUND OF THE INVENTION

1. Field of the Invention

The present invention relates to a communication controlling device, a communication controlling method and an image forming system. In particular, the present invention relates to a communication controlling device comprising data receiving sections for carrying out a data communication by using a plurality of communication tools having different communication systems from each other; a communication controlling method for carrying out a data communication through the plurality of communication tools; and an image forming system comprising the communication controlling device and an image forming device.

2. Description of Related Art

At present, an image forming device, for example, a facsimile, a copy machine, a printer or the like, is generally used as an output device for an input terminal device, for example, a personal computer or the like which is connected with the output device through a predetermined communication tool.

In the input terminal device connected with the image forming device, a data transmitting section (input communication port) peculiar to the input terminal device is previously provided. In order to carry out the data communication between the input terminal device and the image forming device, in general, it is necessary that the data transmitting section of the input terminal device and a data receiving section (output communication port) of the image forming device have the same communication system.

As a communication tool for connecting the input terminal device with the image forming device, for example, a parallel interface, a serial interface and other type of bus are used. As a high-performance input terminal device has been developed, for example, in order to improve the data transfer speed and to use the data transmitting section corresponding to the transferred data, the data transmitting section attached to the input terminal device tends to be diversified. Further, in accordance with the tendency, the data receiving section is correlated with the data transmitting section.

There is some possibility that a user or the like which uses an old type of personal computer (hereinafter, referred to as “PC”) as an input terminal device, cannot connect user's input terminal device with an image forming device, because the data transmitting section of the PC is generally adapted for a different communication system from a data receiving section of the latest image forming device.

On the other hand, as a communication controlling device, for example, a device comprising a plurality of data receiving sections (input communication port) is known. In case of such a communication controlling device, there is some possibility that for example, a plurality of PCs are connected with the data receiving sections corresponding to each data transmitting sections of the PCs, through each predetermined communication tool, and are used in a state that a network system in which the image forming device is used as a common output device for each PC is constructed.

In this case, it is required to previously set the communication between the communication controlling device and the input terminal device by a user in order to determine a communication tool to be used in the data communication, that is, in order to determine the PC which outputs the data for commanding the image forming device to carry out the image forming operation.

In order to solve the above problem, for example, in Japanese Patent Application Publication No. Tokukai-Hei 10-083338, a communication controlling device (multi-port memory) for assigning RAM access time to a plurality of data receiving sections (output communication ports) by a constant time in order, and for temporarily stopping the assignment of the RAM access time to the data receiving section which does not input nor output a data, is disclosed.

In such a communication controlling device, when the input-output of the data is caused in a plurality of data receiving sections simultaneously, a plurality of data can be processed in parallel. However, there are some problems that because the communication controlling program is complicated, the program size becomes larger and other functions are badly influenced. Further, the data processing time becomes longer.

### SUMMARY OF THE INVENTION

The present invention is accomplished in order to solve the above-described problems.

An object of the present invention is to provide a communication controlling device comprising a data receiving section for carrying out a data communication by using a plurality of communication tools having different communication systems from each other, wherein an input terminal device to be connected can be more freely selected, it is not required that a user carries out the communication setting in the communication controlling device when the data communication is carried out, and therefore, the communication controlling device has high operationality and high convenience.

Another object of the present invention is to an image forming system comprising the above new communication controlling device and an image forming device, wherein an input terminal device to be connected can be more freely selected, it is not required that a user carries out the communication setting in the communication controlling device when the data communication is carried out, and therefore, the image forming system has high operationality and high convenience.

That is, in accordance with the first aspect of the present invention, a communication controlling device, comprising:

a communication controller comprising a plurality of data receiving sections for carrying out a data communication by using a plurality of communication tools having different communication systems from each other, the communication controller controlling each operating condition of the plurality of communication tools;

a supervisory controller for previously judging whether a received data received by the communication controller is valid and for carrying out a communication tool selecting process for specifying one communication tool through which data should be continuously transmitted;

a data storage for storing the received data which is judged to be valid by the supervisory controller; and

an access controller for controlling each operating condition of the supervisory controller and the data storage;

wherein the access controller comprises a function for controlling an operating condition of the communication controller so that the data is continuously transmitted through an effective communication tool for the received data which is previously judged to be valid by the supervisory controller, in a state that it is forbidden that the data is transmitted through the other communication tools except the effective communication tool among the plurality of communication tools, while the data is transmitted through the effective communication tool in a state that the data can be transmitted from an outside of the communication controlling device through each of the plurality of communication tools.

According to the communication controlling device, because the communication controller comprises data receiving sections for carrying out a data communication by using a plurality of communication tools having different communication systems from each other, the input terminal device which can be connected with the communication controlling device can be selected more freely. Therefore, for example, even a user which uses an old type of input terminal device can carry out the data communication by connecting the input terminal device with the communication controlling device without changing the input terminal device itself. Because the supervisory controller automatically recognizes the communication tool through which the data should be received, from a plurality of communication tools, it is not required that a complicated communication setting is carried out in the communication controlling device even though a user carries out the data communication by using one communication tool in a state that each of a plurality of communication tools can receive the data from the outside. Therefore, it is possible that the communication controlling device has high operationality and high convenience.

Preferably, in the device according to the first aspect of the present invention, the communication tool selecting process carried out by the supervisory controller is one for specifying one data communication through which the received data which is previously received is transmitted, among the plurality of communication tools by repeatedly carrying out a data reception judging process for judging whether the data is received from the outside, in accordance with a priority designated for each of the plurality of the communication tools; and then carrying out a validity judging process for judging whether the received data transmitted through the communication tool specified by the data reception judging process is valid, to select the communication tool through which the received data judged to be valid by the validity judging process is transmitted, as the effective communication tool.

Preferably, in the device according to the first aspect of the present invention, the access controller comprises a function that when prior data are simultaneously received by each of the data receiving sections of the communication controller, the access controller controls the operating condition of the supervisory controller so that the supervisory controller carries out the communication tool selecting process for the plurality of the communication tools in accordance with a priority which is previously designated, and the access controller controls the operating condition of the communication controller so that the data is continuously transmitted through the communication tool for the received data which is firstly judged to be valid by the communication tool selecting process.

According to the device, when the prior data are simultaneously received by each data receiving section of the receiving controller, the supervisory controller selects one effective communication tool through which the data communication should be carried out to perform a predetermined process for only received data which is transmitted through the effective communication tool. Therefore, the operating condition of each communication tool can be controlled in accordance with the communication controlling program having a simple structure.

Preferably, in the device according to the first aspect of the present invention, each of the plurality of communication tools is one selected from the group consisting of an RS-232C interface, an IEEE1284 interface and a universal serial bus interface.

In accordance with the second aspect of the present invention, an image forming system comprises:

an image forming device; and

a communication controlling device for receiving a data from an outside of the image forming device and forwarding the received data to the image forming device;

wherein the communication controlling device, comprises:

a communication controller comprising a plurality of data receiving sections for carrying out a data communication by using a plurality of communication tools having different communication systems from each other, the communication controller controlling each operating condition of the plurality of communication tools;

a supervisory controller for previously judging whether a received data received by the communication controller is valid and for carrying out a communication tool selecting process for specifying one communication tool through which data should be continuously transmitted;

a data storage for storing the received data which is judged to be valid by the supervisory controller; and

an access controller for controlling each operating condition of the supervisory controller and the data storage;

wherein the access controller comprises a function for controlling an operating condition of the communication controller so that the data is continuously transmitted through an effective communication tool for the received data which is previously judged to be valid by the supervisory controller, in a state that it is forbidden that the data is transmitted through the other communication tools except the effective communication tool among the plurality of communication tools, while the data is transmitted through the effective communication tool in a state that the data can be transmitted from an outside of the communication controlling device through each of the plurality of communication tools.

According to the image forming system, because the image forming device comprises the above-described communication controlling device, the input terminal device to be connected with the communication controlling device can be selected more freely. When the device comprises the data transmitting section (input communication port) which is adapted for the data receiving section of the communication device, it is possible to carry out an expected image forming operation by connecting with the image forming device. Further, even though a user carries out the data communication by using any one of the communication tools in a state that the data can be received from the outside through each of a plurality of communication tools, it is not required that a complicated communication setting is carried out in the communication controlling device. Therefore, it is possible to provide the image forming system having high operationality and high convenience.

Preferably, in the system according to the second aspect of the present invention, the image forming device comprises a flash memory; and

the access controller of the communication controlling device comprises a program updating function for rewriting an operation controlling program for the image forming device, which is rewritably stored in the flash memory, in accordance with the received data through which the effective communication data is transmitted.

Preferably, in the system according to the second aspect of the present invention, the communication tool selecting process carried out by the supervisory controller is one for specifying one data communication through which the received data which is previously received is transmitted, among the plurality of communication tools by repeatedly carrying out a data reception judging process for judging whether the data is received from the outside, in accordance with a priority designated for each of the plurality of the communication tools; and then carrying out a validity judging process for judging whether the received data transmitted through the communication tool specified by the data reception judging process is valid, to select the communication tool through which the received data judged to be valid by the validity judging process is transmitted, as the effective communication tool.

Preferably, in the system according to the second aspect of the present invention, the access controller comprises a function that when prior data are simultaneously received by each of the data receiving sections of the communication controller, the access controller controls the operating condition of the supervisory controller so that the supervisory controller carries out the communication tool selecting process for the plurality of the communication tools in accordance with a priority which is previously designated, and the access controller controls the operating condition of the communication controller so that the data is continuously transmitted through the communication tool for the received data which is firstly judged to be valid by the communication tool selecting process.

Preferably, in the system according to the second aspect of the present invention, each of the plurality of communication tools is one selected from the group consisting of an RS-232C interface, an IEEE1284 interface and a universal serial bus interface.

In accordance with the third aspect of the present invention, a communication controlling method, comprising:

controlling each operating condition of a plurality of communication tools having different communication systems from each other;

previously judging whether a received data received through the plurality of communication tools is valid and carrying out a communication tool selecting process for specifying one communication tool through which data should be continuously transmitted;

storing the received data which is judged to be valid in accordance with the communication tool selecting process; and

controlling each operating condition of the plurality of communication tools so that the data is continuously transmitted through an effective communication tool for the received data which is previously judged to be valid in accordance with the communication tool selecting process, in a state that it is forbidden that the data is transmitted through the other communication tools except the effective communication tool among the plurality of communication tools, while the data is transmitted through the effective communication tool in a state that the data can be transmitted from an outside through each of the plurality of communication tools.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a block diagram for schematically showing a structure of an example of an image forming system according to the present invention;

FIGS. 2 and 3 are a flowchart for showing a process carried out by the communication controlling device when the data communication is carried out; and

FIG. 4 is another flowchart for showing a process carried out by the communication controlling device when the data communication is carried out.

### PREFERRED EMBODIMENT OF THE INVENTION

Hereinafter, the embodiment of the present invention will be explained with reference to the drawings.

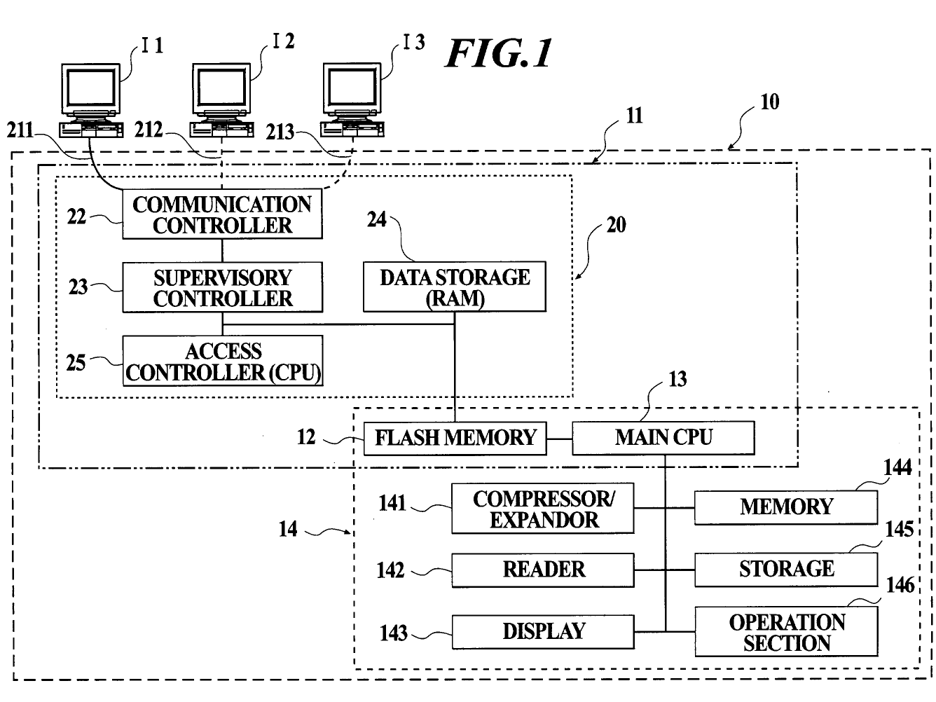

FIG. 1 is a block diagram for schematically showing a structure of an example of an image forming system according to the present invention.

The image forming system comprises an image forming device 10 and a communication controlling device 20 for receiving a data from the outside of the image forming device 10 to forward the received data to the image forming device 10. The communication controlling device 20 is provided in an operation controlling device 11 having a function for controlling a series of the image forming operation, such as copy operation, fax operation, printing operation or the like, in the image forming device 10.

The operation controlling device 11 of the image forming device 10 constituting the image forming system comprises a flash memory 12 in which an operation controlling program for a series of the image forming operation is rewritably stored, and a main CPU 13 for controlling the operating condition of the whole image forming device 10 in accordance with the operation controlling program stored in the flash memory 12.

In an example shown in FIG. 1, a state that a network system in which, for example, three personal computers (PCs) I1, I2 and I3 which are input terminal devices are connected with the communication controlling device 20 through the communication tools 211, 212 and 213 having different communication systems from each other and the image forming device 10 is used as a common output device for all of the PCs is constructed.

As communication tools 211, 212 and 213 for connecting the image forming device 10 with the PCs I1, I2 and I3, a parallel interface, a serial interface and other type of bus can be used. In the concrete, IEEE1284 interface, RS-232C interface, USB (universal serial bus) interface and the like are exemplified.

As shown in FIG. 1 by using a broken line, the communication controlling device 20 comprises a communication controller 22 having the data receiving sections (output communication port) for carrying out a data communication by using three communication tools 211, 212 and 213 having different communication systems from each other; a supervisory controller 23 having a function for carrying out a communication tool selecting process for selecting an effective communication tool through which the data communication is continuously carried out, by previously judging the validity of the received data received by the communication controller 22; a data storage (RAM) 24 for storing the valid received data which is judged to be valid by the supervisory controller 23, and an access controller (CPU) 25 for controlling the operating condition of the communication controller 22, that of the supervisory controller 23 and that of the data storage 24.

The communication controlling device 20 is connected with the flash memory 12 of the operation controlling device 11 in the image forming device 10 and the sections for the image forming operation, such as a compressor/expander 141, a reader 142, a display 143, a memory 144, a storage 145, an operation section 146 of an image forming section 14 and the like, through suitable buses.

The communication controller 22 enables the communication tools 211, 212 and 213 to receive the data from the PCs I1, I2 and I3, respectively, by initializing each hardware setup of the communication tools 211, 212 and 213. Further, the communication controller 22 has a function for forwarding the received data to the data storage (RAM) 24.

As described above, the supervisory controller 23 has a function for carrying out the communication tool selecting process. In the communication tool selecting process, a data reception judging process for judging the communication tool through which the received data received by the communication controller 22 is transmitted, in accordance with a flowchart which will be explained below, is carried out. Further, in the communication tool selecting process, the effective communication tool through which the data communication is continuously carried out, is selected by previously carrying out the validity judging process for judging the validity of the received data.

The access controller 25 stores the valid received data which is judged to be valid in the validity judging process by the supervisory controller 23, in the data storage 24. Further, the access controller 25 has a function for controlling the operating condition of the communication controller 22 so as to continuously carry out the data communication through the effective communication tool until all of the necessary data is received in a state that the data communication to be carried out by the other communication tools is forbidden while the effective communication tool is in a communication state.

Further, the access controller 25 can have a program updating function for carrying out a rewriting process of the operation controlling program stored in the flash memory 12, in accordance with the valid received data when the valid received data is an update controlling program for updating the operation controlling program stored in the flash memory 12.

The image forming device 10 carries out an image forming operation in accordance with the valid received data relating to a series of operating information transmitted from the PC under the control of the operation controlling program stored in the flash memory 12.

For example, in order to improve the performance by adding the function and to respond to the user's needs, there is some possibility that it is required to change or update the operation controlling program. In this case, the update of the operation controlling program is carried out, for example, by transmitting the updated operation controlling program from the PC connected with the image forming device 10.

Hereinafter, the communication controlling method of the communication controlling device 20 in the image forming system according to the present invention, will be explained.

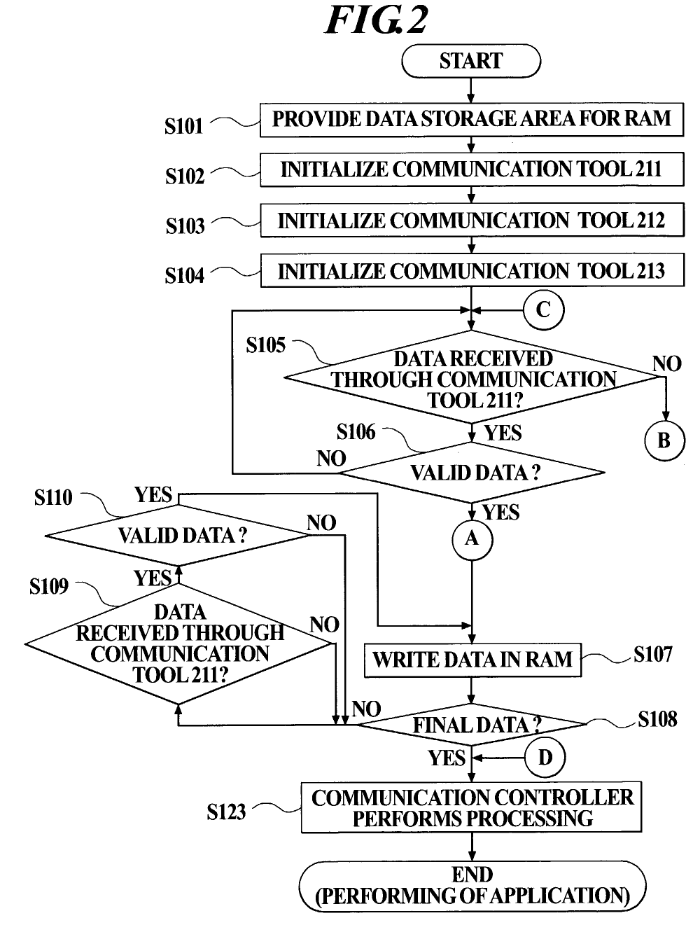

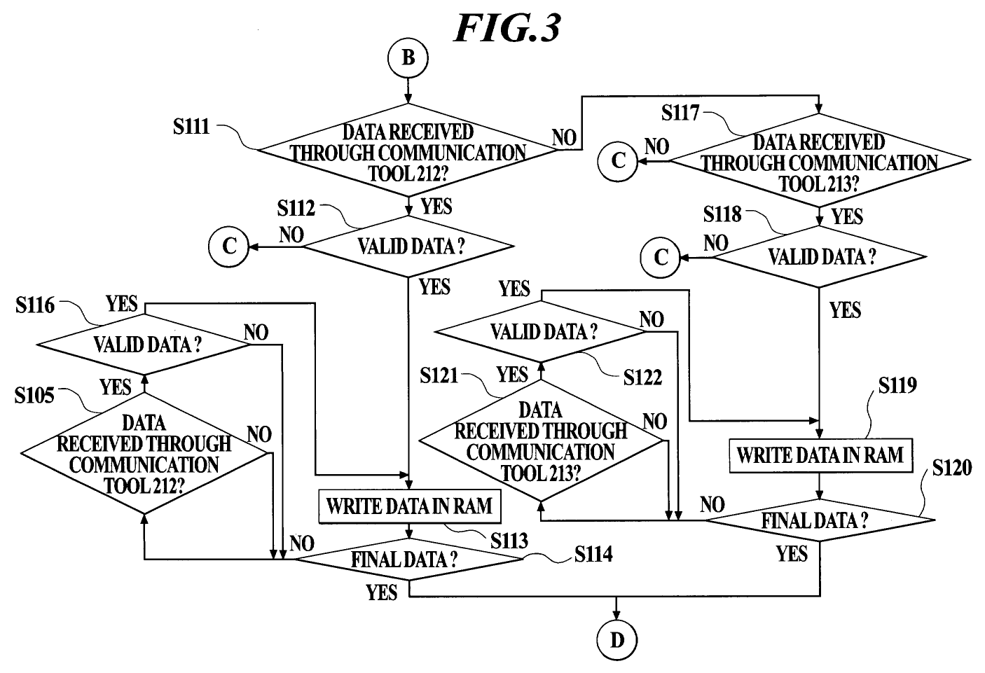

FIGS. 2 and 3 are a flowchart for showing a process carried out by the communication controlling device when the data communication is carried out.

When the image forming device 10 is switched on, the operating condition of the communication controlling section 22 is controlled by the access controller 25 of the communication controlling device 20. The communication controlling device 20 provides the data storage area for storing data to be transmitted from the PCs I1, I2 and I3 connected with the communication controlling device 20, for the data storage (RAM) 24 corresponding to each communication tool 211, 212 and 213 (Step S101). The communication controlling device 20 initializes each hardware setup of the communication tools 211, 212 and 213 to enable each communication tool 211, 212 and 213 to carry out the data communication so as to receive the data even though the data is transmitted from any PC (Step S102, S103 and S104).

When the data for setting the operation relating to a series of operating information is transmitted from one of the PCs I1, I2 and I3 connected with the image forming device 10 and the communication controlling device 20 receives the data, the communication controlling device 20 temporarily stores the received data which is previously received (hereinafter, referred to as “prior received data”), in a register (not shown in the drawings) corresponding to the communication tool for the prior received data. Then, the supervisory controller 23 carries out the communication tool selecting process for selecting the effective communication tool through which the data communication is continuously carried out.

That is, the supervisory controller 23 repeatedly carries out the data reception judging process for judging whether the prior received data is stored in the register by detecting the using condition of the register for each communication tool 211, 212 and 213 in accordance with the priority (in an example shown in FIGS. 2 and 3, the priority is designated in the order of the communication tools 211, 212 and 213.) which is previously designated, until the communication tool through which the prior received data is received is confirmed (Step S105, S111 and S117).

Next, when the supervisory controller 23 confirms the communication tool through which the prior received data is received (Step S105, S111, S117; Yes), the validity judging process for judging the validity (necessity) of the prior received data is carried out (Step S106, S112 and S118). The supervisory controller 23 judges the validity of the prior received data, for example, in the following method. However, the present invention is not limited to this method. When the error of the data is detected, it is possible to use a method which is suitably used in an earlier development.

Method for Judging the Validity of the Data

The data transmitted from each PC I1, I2 and I3 is received through the communication tools 211, 212 and 213, respectively, for example, by treating data capacity having a predetermined size (the number of bytes) as one communication unit (hereinafter, referred to as “1 data packet”). In each data packet, the identification information, such as data capacity (the number of bytes) is included so as to correlate with the transmitting order of the data packet. Therefore, the supervisory controller 23 judges the validity of the received data by comparing the data capacity of the prior received data (1 data packet) to be received with the data capacity of the prior received data which is actually received through the communication tool. When both of the data capacities are coincident, the supervisory controller 23 judges that the received data is valid.

When it is judged that the prior received data stored in the register is valid (Step S106, S112 and S118; Yes), the supervisory controller 23 selects the communication tool for the valid received data as an effective communication tool through which the data communication is continuously carried out. The access controller 25 carries out a process for transmitting the valid received data to the data storage area of the data storage 24, which is previously provided for each communication tool, to write the data in the data storage 24 (Step S107, S113 and S119). The access controller 25 controls the operating condition of the communication controller 22 so as to command the communication controller 22 to continuously carry out the data communication by the effective communication tool in a state that the data communication to be carried out by the communication tools except the effective communication tool is forbidden while the effective communication tool is in a communication state.

On the other hand, when it is judged that the prior received data is invalid in the validity judging process (Step S106, S112 and S118; No), the supervisory controller 23 carries out the data reception judging process for all of the communication tools including the communication tool which was treated as the effective communication tool, again. In the reception judging process, the same communication tool may be selected. As described above, the supervisory controller 23 judges the data is invalid, for example, when the data capacity of the data which is actually received by the communication controller 22 is not coincident with the identification information of the data.

The supervisory controller 23 carries out the judging process for judging whether the valid received data stored in the data storage (RAM) 24 is a final data, that is, for judging whether all of the required data is received (Step S108, S114 and S120).

In the concrete, the judging process for judging whether the data stored in the data storage 24 is a final data, is carried out by the supervisory controller 23 as follows. That is, in the identification information transmitted from the PC with the data, the information relating to the total data capacity of the data to be received is included. Therefore, the supervisory controller 23 carries out the judging process by comparing the total data capacity of the valid received data which is actually stored in the data storage 24 with the total data capacity included in the identification information. When both of the total data capacities are coincident, it is judged that the data included in the data packet which is finally written in the data storage 24 is a final data.

In a state that all of the required data is received (Step S108, S114 and S120; Yes), when the supervisory controller 23 confirms that the all of the received data is valid, the communication controlling device 20 carries out a predetermined process for an expected image forming operation in accordance with the operating information for a series of the valid received data (Step S123).

On the other hand, when it is confirmed that all of the required data is not received (Step S108, S114 and S120; No), the supervisory controller 23 repeatedly carries out the data reception judging process (Step S109, S115 and S121), the validity judging process (Step S110, S116 and S122) and the writing process (Step S107, S113 and S119) for writing the data in data storage (RAM) 24 until it is confirmed that all of the required data is received and all of the following received data is valid.

When the prior data for setting the operation are simultaneously received by each data receiving sections of the communication controller 22, each of these prior received data which is previously received is stored in the register corresponding to each communication tool 211, 212 and 213, respectively. Then, the data reception judging process is carried out for the prior received data stored in the register in accordance with the designated priority. Therefore, the validity judging process is carried out for only the prior received data which is judged to be firstly stored in the register. When it is judged that the prior received data is valid, the communication tool for the valid received data is selected as an effective communication tool through which the data communication is carried out. As a result, while the effective communication tool is in a data communication state, the data communication is carried out through the effective communication tool in a state that the data communication to be carried out by the communication tools except the effective communication tool is forbidden.

As described above, for example, in case that the validity received data stored in the data storage 24 is a data relating to the update operation controlling program for updating the operation controlling program stored in the flash memory 11, when all of the required data is received and is judged to be valid in the validity judging process and the writing process for writing the valid received data is written in the data storage 24 is finished, the present operation controlling program which is currently stored in the flash memory 11 is rewritten by the access controller 25 of the communication controlling device 20 in accordance with the update operation controlling program which is the valid received data.

In the concrete, in order to rewrite the present operation controlling program, for example, it is possible to use (1) the method for rewriting the received update operation controlling program after the present operation controlling program stored in the flash memory 11 is deleted once, (2) the method for carrying out the rewriting operation in the data storage 24 by copying only the updated part of the operation controlling program corresponding to the update operation controlling program from the flash memory 11 to the data storage 24 to write the updated part of the update operation controlling program in the flash memory 11, or the like.

According to the communication controlling device 20 of the present invention, because the communication controlling device 20 comprises data receiving sections (output communication ports) for carrying out a data communication by using a plurality of communication tools having different communication systems from each other, the PC (input terminal device) having a data transmitting section (input communication port) which is connectable with the data receiving section of the communication controlling device 20, can be connected with the communication controlling device 20. Therefore, a user can select the PC to be connected with the communication controlling device 20 more freely.

Therefore, for example, a user which uses an old type of PC (generally, the data transmitting section attached to the PC is also an old type.) can connect the PC with the communication controlling device 20 without changing the PC itself to carry out a data communication.

Further, because the supervisory controller 23 automatically recognizes the communication tool through which the data should be received, it is not required that the complicated communication setting for PCs, which is necessary for a conventional device when a plurality of communication tools having different communication systems from each other are connected, such as the select of the communication tool through which the data communication should be carried out, is carried out by a user in the communication controlling device 20.

Therefore, it is possible that the communication controlling device 20 has high operationality and high convenience.

When prior data are simultaneously received by each data receiving section of the receiving controller 22 in a state that a plurality of communication tools can receive the data from each PC, the supervisory controller 23 selects one effective communication tool through which the data communication for the following data should be carried out to perform a predetermined process for only received data which is transmitted through the effective communication tool. Therefore, the operating condition of each communication tool can be controlled in accordance with the communication controlling program having a simple structure. As a result, when the received data is the updated operation controlling program for the flash memory 12 of the image forming device 10 or the like, it is possible to shorten the processing time for the received data as compared with the parallel process for the received data transmitted through all of the communication tools and to prevent a bad influence on other functions.

The data communication for the following data from the selected effective communication tool is continuously carried out in a state that the data communication to be carried out by the communication tools except the effective communication tool is forbidden while the effective communication tool is in a communication state. Thereby, it is possible to control the operating condition of each communication tool by the communication controlling program having a simple structure. Therefore, it is possible to advantageously carry out an expected data communication.

According to the image forming system of the present invention, which comprises the above communication controlling device 20, a user can select the PC to be connected with the communication controlling device 20 more freely. Thereby, when the PC comprises a data transmitting section which is adapted for the data receiving section of the communication device 20, it is possible to carry out an expected image forming operation by connecting with the image forming device 10. Further, even though a user carries out a data communication by using any one of the communication tools in a state that the data can be received from the PC, it is not required that a complicated communication setting for PCs is carried out in the communication controlling device 20. Therefore, it is possible to provide the image forming system having high operationality and high convenience.

As described above, the concrete embodiment of the present invention is explained. However, the present invention is not limited to the embodiment. Various modifications can be adapted.

For example, in the communication controlling device 20, the combination of the communication systems of the communication tools, the number of the communication tools, the priority of the communication tools, which is used in the communication tool selecting process, or the other concrete construction can be suitably set.

In case that the input terminal device comprises a data transmitting section which can be connected through a predetermined connecting tool, the input terminal device is not limited to a PC. For example, as an input terminal device, an information terminal apparatus, other office machine or the like can be used.

Further, like the example shown in FIG. 1, it is not necessary that the operation controlling device 11 is constructed by providing the elements constituting the communication controlling device 20 on a main board for controlling the operation of the whole image forming device 10. The construction that the communication controlling device 20 itself is connected with the operation controlling device 11 as an interface for the communication control by providing an optional communication controlling board on which all of the elements including the communication controller 22, the supervisory controller 23 and the access controller 25 are arranged, may be adapted.

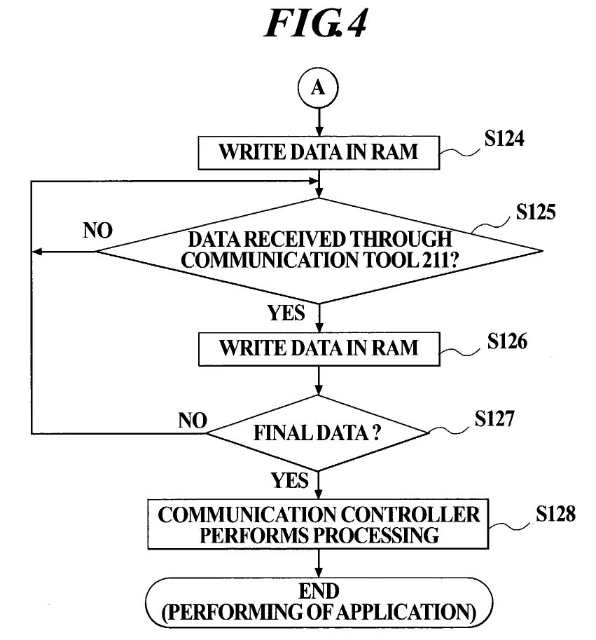

The communication controlling device 20 may carry out the process shown in FIG. 4 after the prior received data is written in the data storage (RAM) 24 (Step S107) in the process (flowchart) shown in FIGS. 2 and 3. That is, after the prior received data is written in the data storage (RAM) 24 (Step S124), the communication controlling device 20 may successively carry out the data reception judging process for the following data (data packet) (Step S125) to carry out the judging process for judging whether the received data is a final data, from the second data packet. When it is judged that the prior received data is valid, the communication controlling device 20 may carry out the writing process (Step S126) for the data storage (RAM) 24 without carrying out the validity judging process for the following received data. The communication controlling device 20 may carry out a process (Step S127) until it is confirmed that all of the received data are valid and then carry out a process for an expected image forming operation (Step S128).

As explained above, according to the image forming device of the present invention, the following effects can be obtained.

According to the communication controlling device of the present invention, because the communication controller comprises data receiving sections for carrying out a data communication by using a plurality of communication tools having different communication systems from each other, the input terminal device which can be connected with the communication controlling device can be selected more freely. Therefore, for example, even a user which uses an old type of input terminal device can carry out the data communication by connecting the input terminal device with the communication controlling device without changing the input terminal device itself. Because the supervisory controller automatically recognizes the communication tool through which the data should be received, from a plurality of communication tools, it is not required that a complicated communication setting is carried out in the communication controlling device even though a user carries out the data communication by using one communication tool in a state that each of a plurality of communication tools can receive the data from the outside. Therefore, it is possible that the communication controlling device has high operationality and high convenience.

When the prior data are simultaneously received by each data receiving section of the receiving controller, the supervisory controller selects one effective communication tool through which the data communication should be carried out to perform a predetermined process for only received data which is transmitted through the effective communication tool. Therefore, the operating condition of each communication tool can be controlled in accordance with the communication controlling program having a simple structure. As a result, it is possible to suitably carry out an expected data communication without having a bad influence on other functions.

According to the image forming system of the present invention, because the image forming device comprises the above-described communication controlling device, the input terminal device to be connected with the communication controlling device can be selected more freely. When the device comprises the data transmitting section (input communication port) which is adapted for the data receiving section of the communication device, it is possible to carry out an expected image forming operation by connecting with the image forming device. Further, even though a user carries out the data communication by using any one of the communication tools in a state that the data can be received from the outside through each of a plurality of communication tools, it is not required that a complicated communication setting is carried out in the communication controlling device. Therefore, it is possible to provide the image forming system having high operationality and high convenience.

The entire disclosure of Japanese Patent Application No. Tokugan 2002-62043 filed on Mar. 7, 2002 including specification, claims drawings and summary are incorporated herein by reference in its entirety.

What is claimed is:

1. A communication controlling device, comprising:
a communication controller comprising a plurality of data receiving sections for carrying out a data communication by using a plurality of communication tools having different communication systems from each other, the communication controller controlling each operating condition of the plurality of communication tools;
a supervisory controller for previously judging whether a received data received by the communication controller is valid and for carrying out a communication tool selecting process for specifying one communication tool through which data should be continuously transmitted;
a data storage for storing the received data which is judged to be valid by the supervisory controller; and
an access controller for controlling each operating condition of the supervisory controller and the data storage;
wherein the access controller comprises a function for controlling an operating condition of the communication controller so that the data is continuously transmitted through an effective communication tool for the received data which is previously judged to be valid by the supervisory controller, in a state that it is forbidden that the data is transmitted through the other communication tools except the effective communication tool among the plurality of communication tools, while the data is transmitted through the effective communication tool in a state that the data can be transmitted from an outside of the communication controlling device through each of the plurality of communication tools.

2. The device of claim 1, wherein the communication tool selecting process carried out by the supervisory controller is one for specifying one data communication through which the received data which is previously received is transmitted, among the plurality of communication tools by repeatedly carrying out a data reception judging process for judging whether the data is received from the outside, in accordance with a priority designated for each of the plurality of the communication tools; and then carrying out a validity judging process for judging whether the received data transmitted through the communication tool specified by the data reception judging process is valid, to select the communication tool through which the received data judged to be valid by the validity judging process is transmitted, as the effective communication tool.

3. The device of claim 1, wherein the access controller comprises a function that when prior data are simultaneously received by each of the data receiving sections of the communication controller, the access controller controls the operating condition of the supervisory controller so that the supervisory controller carries out the communication tool selecting process for the plurality of the communication tools in accordance with a priority which is previously designated, and the access controller controls the operating condition of the communication controller so that the data is continuously transmitted through the communication tool for the received data which is firstly judged to be valid by the communication tool selecting process.

4. The device of claim 1, wherein each of the plurality of communication tools is one selected from the group consisting of an RS-232C interface, an IEEE1284 interface and a universal serial bus interface.

5. An image forming system comprising:
an image forming device; and
a communication controlling device for receiving a data from an outside of the image forming device and forwarding the received data to the image forming device;
wherein the communication controlling device, comprises:
a communication controller comprising a plurality of data receiving sections for carrying out a data communication by using a plurality of communication tools having different communication systems from each other, the communication controller controlling each operating condition of the plurality of communication tools;
a supervisory controller for previously judging whether a received data received by the communication controller is valid and for carrying out a communication tool selecting process for specifying one communication tool through which data should be continuously transmitted;
a data storage for storing the received data which is judged to be valid by the supervisory controller; and
an access controller for controlling each operating condition of the supervisory controller and the data storage;
wherein the access controller comprises a function for controlling an operating condition of the communication controller so that the data is continuously transmitted through an effective communication tool for the received data which is previously judged to be valid by the supervisory controller, in a state that it is forbidden that the data is transmitted through the other communication tools except the effective communication tool among the plurality of communication tools, while the data is transmitted through the effective communication tool in a state that the data can be transmitted from an outside of the communication controlling device through each of the plurality of communication tools.

6. The system of claim 5, wherein the image forming device comprises a flash memory; and
the access controller of the communication controlling device comprises a program updating function for rewriting an operation controlling program for the image forming device, which is rewritably stored in the flash memory, in accordance with the received data through which the effective communication data is transmitted.

7. The system of claim 5, wherein the communication tool selecting process carried out by the supervisory controller is one for specifying one data communication through which the received data which is previously received is transmitted, among the plurality of communication tools by repeatedly carrying out a data reception judging process for judging whether the data is received from the outside, in accordance with a priority designated for each of the plurality of the communication tools; and then carrying out a validity judging process for judging whether the received data transmitted through the communication tool specified by the data reception judging process is valid, to select the communication tool through which the received data judged to be valid by the validity judging process is transmitted, as the effective communication tool.

8. The system of claim 5, wherein the access controller comprises a function that when prior data are simultaneously received by each of the data receiving sections of the communication controller, the access controller controls the operating condition of the supervisory controller so that the supervisory controller carries out the communication tool selecting process for the plurality of the communication tools in accordance with a priority which is previously designated, and the access controller controls the operating condition of the communication controller so that the data is continuously transmitted through the communication tool for the received data which is firstly judged to be valid by the communication tool selecting process.

9. The system of claim 5, wherein each of the plurality of communication tools is one selected from the group consisting of an RS-232C interface, an IEEE1284 interface and a universal serial bus interface.

10. A communication controlling method, comprising:
controlling each operating condition of a plurality of communication tools having different communication systems from each other;
previously judging whether a received data received through the plurality of communication tools is valid and carrying out a communication tool selecting process for specifying one communication tool through which data should be continuously transmitted;
storing the received data which is judged to be valid in accordance with the communication tool selecting process; and
controlling each operating condition of the plurality of communication tools so that the data is continuously transmitted through an effective communication tool for the received data which is previously judged to be valid in accordance with the communication tool selecting process, in a state that it is forbidden that the data is transmitted through the other communication tools except the effective communication tool among the plurality of communication tools, while the data is transmitted through the effective communication tool in a state that the data can be transmitted from an outside through each of the plurality of communication tools.

11. The method of claim 10, wherein the communication tool selecting process is one for specifying one data communication through which the received data which is previously received is transmitted, among the plurality of communication tools by repeatedly carrying out a data reception judging process for judging whether the data is received from the outside, in accordance with a priority designated for each of the plurality of the communication tools; and then carrying out a validity judging process for judging whether the received data transmitted through the communication tool specified by the data reception judging process is valid, to select the communication tool through which the received data judged to be valid by the validity judging process is transmitted, as the effective communication tool.

12. The method of claim 10, further comprising:
carrying out the communication tool selecting process for the plurality of the communication tools in accordance with a priority which is previously designated, and controlling each operating condition of the plurality of communication tools so that the data is continuously transmitted through the communication tool for the received data which is firstly judged to be valid by the communication tool selecting process when prior data are simultaneously received through each of a plurality of communication tools.

13. The method of claim 10, wherein each of the plurality of communication tools is one selected from the group consisting of an RS-232C interface, an IEEE1284 interface and a universal serial bus interface.
